(19) United States
(12) Patent Application Publication
(10) Pub. No.: US 2016/0110543 A1
(43) Pub. Date: Apr. 21, 2016

(54) APPARATUS AND METHOD FOR DETECTING MALICIOUS APPLICATION BASED ON VISUALIZATION SIMILARITY

(71) Applicant: Electronics and Telecommunications Research Institute, Daejeon (KR)

(72) Inventors: Won Joo PARK, Daejeon (KR); Kyong Ha LEE, Daejeon (KR); Kee Seong CHO, Daejeon (KR)

(21) Appl. No.: 14/808,002

(22) Filed: Jul. 24, 2015

(30) Foreign Application Priority Data
Oct. 21, 2014 (KR) 10-2014-0142824

(51) Int. Cl. G06F 21/55

(52) U.S. Cl. CPC G06F 21/554; G06F 2221/033

(57) ABSTRACT

The present invention provides a malicious application detecting apparatus based on a visualization similarity, including: a first storing unit which classifies malicious applications for every group in accordance with characteristics and stores the malicious applications; a second storing unit which stores a target application; an image generating unit which analyzes the malicious applications to generate first visualization images and analyzes the target application to generate a second visualization image; a representative image selecting unit which selects representative images for every group using a similarity of the first visualization images; and a determining unit which compares the representative images with the second visualization image to determine whether the target application is a malicious application.

### CROSS-REFERENCE TO RELATED APPLICATIONS

This application claims priority to and the benefit of Korean Patent Application No. 10-2014-0142824 filed in the Korean Intellectual Property Office on Oct. 21, 2014, the entire contents of which are incorporated herein by reference.

### TECHNICAL FIELD

The present invention relates to an apparatus and a method for detecting a malicious application based on a visualization similarity.

### BACKGROUND ART

As usage of a smart phone is increased, mobile financial fraud cases have suddenly increased. Not only phishing and pharming, but also a smishing attack which induces installation of a malicious application (for example, .apk file or malware) or asks for personal information and induces cellular phone micro payment has increased in recent years.

In the mobile environment (specifically, an environment of an android operating system), the financial fraud method installs malicious application in a user terminal while a user does not recognize and leaks personal information through the malicious application. Specifically, the financial fraud method in the mobile environment transmits a URL which induces installation of a malicious application using a SMS/MMS or a mobile message and when the user clicks the URL, the method induces a malicious application package file to be downloaded.

In the meantime, in the case of the android operating system, the operating system is open to the public and an application which is registered in a third party market other than Google play store is also installed so that the android operating system is relatively at risk as compared with other mobile operating systems. Therefore, a technology which detects the malicious application is required.

### SUMMARY OF THE INVENTION

The present invention has been made in an effort to provide an apparatus and a method for detecting a malicious application based on a visualization similarity which may efficiently detect a malicious application.

Technical objects of the present invention are not limited to the aforementioned technical objects and other technical objects which are not mentioned will be apparently appreciated by those skilled in the art from the following description.

An exemplary embodiment of the present invention provides a malicious application detecting apparatus based on a visualization similarity, including: a first storing unit which classifies malicious applications for every group in accordance with characteristics and stores the malicious applications; a second storing unit which stores a target application; an image generating unit which analyzes the malicious applications to generate first visualization images and analyzes the target application to generate a second visualization image; a representative image selecting unit which selects representative images for every group using a similarity of the first visualization images; and a determining unit which compares the representative images with the second visualization image to determine whether the target application is a malicious application.

According to an exemplary embodiment, the apparatus may further include a processing unit when it is determined that the target application is a malicious application, classifies the target application into a corresponding group to store the target application in the first storing unit.

According to an exemplary embodiment, the image generating unit may decompress a package file of the malicious applications to extract at least one of an execution file, a resource access permission file, and a metadata file.

According to the exemplary embodiment, the image generating unit may decompile the execution file to extract a source code and generate the first visualization images based on the source code.

According to the exemplary embodiment, the image generating unit may generate a function list related to a malicious behavior or a character string list related to the malicious behavior based on the source code.

According to the exemplary embodiment, the image generating unit may decompress a package file of the target applications to extract at least one of an execution file, a resource access permission file, and a metadata file.

According to the exemplary embodiment, the image generating unit may decompile the execution file to extract a source code and generate the second visualization images based on the source code.

According to the exemplary embodiment, the image generating unit may generate a malicious behavior suspicious function list or a malicious behavior suspicious character string list based on the source code.

According to the exemplary embodiment, the apparatus may further include an analysis difficulty determining unit which, when it is determined that the target application is a malicious application, determines analysis difficulty of the target application.

According to the exemplary embodiment, the analysis difficulty determining unit may determine analysis difficulty of the target application based on a similarity between the second visualization image of the target application and a representative image for every group, the number of malicious applications for every group, and a frequency of generation of a malicious application for every group recently.

Another exemplary embodiment of the present invention provides a malicious application detecting method based on a visualization similarity, including: analyzing malicious applications stored for every group in accordance with characteristics to generate first visualization images and analyzing a target application to generate a second visualization image; selecting representative images for every group using a similarity of the first visualization images; and comparing the representative images with the second visualization image to determine whether the target application is a malicious application.

According to the exemplary embodiment, in the analyzing of malicious applications stored for every group in accordance with characteristics to generate first visualization images and the analyzing of a target application to generate a second visualization image; a package file of the malicious applications may be uncompressed to extract at least one of an execution file, a resource access permission file, and a metadata file.

According to the exemplary embodiment, in the analyzing of malicious applications stored for every group in accordance with characteristics to generate first visualization images and the analyzing of a target application to generate a second visualization image; the execution file may be decompiled to extract a source code and generate the first visualization images based on the source code.

According to the exemplary embodiment, in the analyzing of malicious applications stored for every group in accordance with characteristics to generate first visualization images and the analyzing of a target application to generate a second visualization image; a function list related with a malicious behavior or a character string list related with the malicious behavior may be generated based on the source code.

According to the exemplary embodiment, in the analyzing of malicious applications stored for every group in accordance with characteristics to generate first visualization images and the analyzing of a target application to generate a second visualization image; the resource access permission file may be analyzed to generate an access permission list.

According to the exemplary embodiment, in the analyzing of malicious applications stored for every group in accordance with characteristics to generate first visualization images and the analyzing of a target application to generate a second visualization image; a package file of the target applications may be decompressed to extract at least one of an execution file, a resource access permission file, and a metadata file.

According to the exemplary embodiment, in the analyzing of malicious applications stored for every group in accordance with characteristics to generate first visualization images and the analyzing of a target application to generate a second visualization image; the execution file may be decompiled to extract a source code and generate the second visualization images based on the source code.

According to the exemplary embodiment, in the analyzing of malicious applications stored for every group in accordance with characteristics to generate first visualization images and the analyzing of a target application to generate a second visualization image; a malicious behavior suspicious function list or a malicious behavior suspicious character string list may be generated based on the source code.

According to the exemplary embodiment, the method may further include: classifying the target application into a corresponding group to store the target application when it is determined that the target application is a malicious application; and determining analysis difficulty of the target application when it is determined that the target application is a malicious application.

According to the exemplary embodiment, in the determining of analysis difficulty of the target application when it is determined that the target application is a malicious application, analysis difficulty of the target application may be determined based on at least one of a similarity between the second visualization image of the target application and a representative image for every group, the number of malicious applications for every group, and a frequency of generation of a malicious application for every group recently.

According to the apparatus and the method for detecting a malicious application based on a visualization similarity of the exemplary embodiment of the present invention, it is possible to distribute among malicious application analyzers according to analysis difficulty and effciently detect a malicious application.

### BRIEF DESCRIPTION OF THE DRAWINGS

FIG. 1 is a block diagram illustrating a malicious application detecting apparatus based on a visualization similarity according to an exemplary embodiment of the present invention.

FIG. 2 specifically illustrates an operation of a malicious application detecting apparatus based on a visualization similarity according to an exemplary embodiment of the present invention.

FIG. 3 is a flow chart illustrating a malicious application detecting method based on a visualization similarity according to an exemplary embodiment of the present invention.

FIG. 4 is a block diagram illustrating a malicious application detecting apparatus based on a visualization similarity according to another exemplary embodiment of the present invention.

FIG. 5 is a flow chart illustrating a malicious application detecting method based on a visualization similarity according to another exemplary embodiment of the present invention.

FIG. 6 is a block diagram illustrating a computing system which executes a malicious application detecting method based on a visualization similarity according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some embodiments of the present invention will be described in detail with reference to the accompanying drawings. In the drawings, even though parts are illustrated in different drawings, it should be understood that like reference numbers refer to the same or equivalent parts of the present invention throughout the several figures of the drawing. In describing the embodiments of the present invention, when it is determined that the detailed description of the known art related to the present invention may obscure the gist of the present invention, the detailed description thereof will be omitted.

In describing parts of the exemplary embodiment of the present invention, terminologies such as first, second, A, B, (a), (b), and the like may be used. However, such terminologies are used only to distinguish a component from another component but a nature or an order of the component is not limited by the terminology. If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Hereinafter, an application may refer to an application based on an android operating system, but is not limited thereto. Further, a malicious application may be used as a concept including malware or a malicious code.

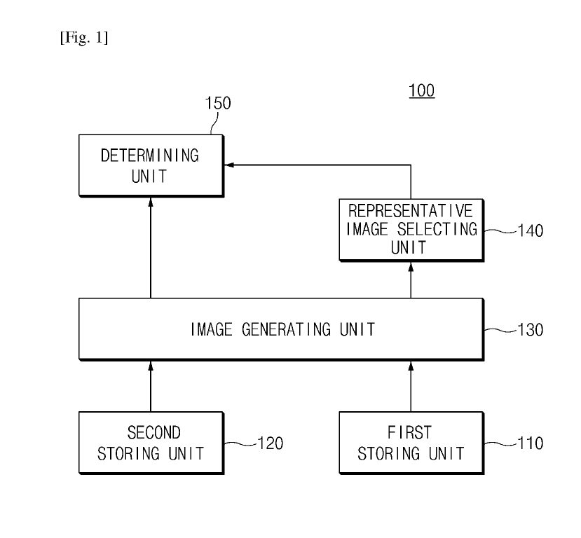

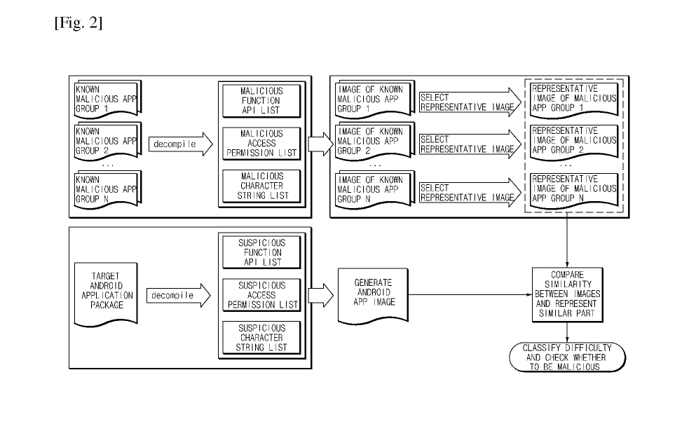

FIG. 1 is a block diagram illustrating a malicious application detecting apparatus based on a visualization similarity according to an exemplary embodiment of the present invention. FIG. 2 specifically illustrates an operation of a malicious application detecting apparatus based on a visualization similarity according to an exemplary embodiment of the present invention.

First, referring to FIG. 1, a malicious application detecting apparatus 100 based on a visualization similarity according to an exemplary embodiment of the present invention 100 may include a first storing unit 110, a second storing unit 120, an image generating unit 130, a representative image selecting unit 140, and a determining unit 150.

The first storing unit 110 may classify malicious applications into groups in accordance with characteristics and store the malicious applications. Here, the “group” may have a meaning of a “family” or be called “family”. The first storing unit 110 may include metadata such as an android malicious application package file having apk as an extension, information of the file, a group name of the malicious application, the number of malicious applications included in each group, information of a first-time discovered time, information of a recently discovered time, and the number of malicious applications of a group which is discovered during a recently designated period.

The second storing unit 120 may store a target application. The target application may mean an application which is a detecting target to determine whether to be a malicious application. For example, the target application is downloaded through an URL which is included in a message to be stored or is stored by a user (or a manager). The second storing unit 120 may store metadata such as an android application package file having apk as an extension, information of the file, a name of the file, and a stored time.

Even though the first storing unit 110 and the second storing unit 120 are illustrated as separate configurations in FIG. 1, the first storing unit 110 and the second storing unit 120 may be implemented by one configuration (for example, a single storing unit) which are functionally divided.

The image generating unit 130 analyzes the malicious applications to generate first visualization images. For example, the image generating unit 130 decompresses a package file of the malicious applications which are stored in the first storing unit 110 to extract at least one of an execution file (for example, classes.dex), a resource access permission file (androidmanifest.xml), and a metadata file. The execution file may mean a file which is executed in a Dalvic virtual machine. The image generating unit 130 may decompile the execution file (classes.dex) to extract a source code. For example, the source code may be a Java source code. The image generating unit 130 may generate first visualization images based on the source code.

The image generating unit 130 may generate a function list related with a malicious behavior or a character string list related with the malicious behavior based on the source code. The function list related with a malicious behavior may include a function list related with a malicious behavior such as illegal access to a terminal resource, and illegal leakage of personal information stored in a terminal. The character string list related with a malicious behavior may include a list which includes an SMS message including a micro payment confirmation number or a character string such as a URL address for transmitting a CAPTCHA code which induces installation of a malware. Further, the image generating unit 130 analyzes the resource access permission file to generate an access permission list.

The image generating unit 130 may analyze the target application to generate a second visualization image. For example, the image generating unit 130 decompresses a package file of the target application which is stored in the second storing unit 120 to extract at least one of an execution file (for example, classes.dex), a resource access permission file (androidmanifest.xml), and a metadata file. The image generating unit 130 may decompile the execution file (classes.dex) to extract a source code. For example, the source code may be a Java source code. The image generating unit 130 may generate a second visualization image based on the source code.

The image generating unit 130 may generate a malicious behavior suspicious function or a malicious behavior suspicious character string list based on the source code. For example, the malicious behavior suspicious function list may refer to a list of functions which are suspicious to correspond to a function list related with the malicious behavior. For example, the malicious behavior suspicious character string list may refer to a list of functions which are suspicious to correspond to a character string list related with the malicious behavior.

The first visualization image and the second visualization image which have been described above may be call flow graph (CFG) images. The CFG image may be defined as a graph image which visually represents an executing flow and a structure of the source code of the program. For example, the CFG image may refer to an image which is visually shown by tracking a path executed from an entry point at which the function starts, as a graph image which represents a function or a flow of a method. Further, the first visualization image and the second visualization image may include a call connection relationship of a function and analysis on a job related with an activity life cycle and a thread.

The representative image selecting unit 140 may select representative images for every group using similarity of the first visualization images. For example, the representative image selecting unit 140 calculates a similarity between the first visualization images of the malicious applications which belongs to each group to select the first visualization image of the malicious application having the highest similarity as a representative image of the group. For example, the representative image selecting unit 140 may select a representative image based on an isomorphism method, an edit distance method, a maximum common sub-graph generating method, or a statistical similarity method.

The determining unit 150 compares representative images with the second visualization image to determine whether the target application is a malicious application. For example, the determining unit 150 calculates a similarity between the representative images and the second visualization image using a graph similarity comparing method and determines whether the target application is a malicious application based on the calculated similarity. Further, the determining unit 150 compares the representative images with the second visualization image to represent similar parts on the visualization image.

Referring to FIG. 2, an operation of the malicious application detecting apparatus 100 based on a visualization similarity according to an exemplary embodiment of the present invention will be described in detail. The image generating unit 130 may extract source codes from execution files of the malicious applications (that is, already known malicious applications) stored in the first storing unit 110 and generate first visualization images using source code. Further, the image generating unit 130 may generate function lists related with the malicious behavior (malicious function API lists), access permission lists (malicious access permission lists), and character string lists (malicious character string lists) related with the malicious behavior.

The image generating unit 130 extracts the source code from the execution file of the target application and generate the second visualization image using a source code. Further, the image generating unit 130 may generate a malicious behavior suspicious function list (a suspicious function API list), a suspicious access permission list (a suspicious access permission list), and a malicious behavior suspicious character string list (a suspicious character string list).

The representative image selecting unit 140 may select representative images for every group among the first visualization images.

The determining unit 150 may compare a similarity of representative images and the second visualization image to determine whether the target application is a malicious application and represent a similar part.

As described above, the malicious application detecting apparatus 100 based on a visualization similarity according to the exemplary embodiment of the present invention may compare similarities of the representative images for every group of the malicious applications and the visualization image of the target application to determine whether the target application is a malicious application. Therefore, it is possible to intuitively and visually transmit a detecting result regarding whether the target application is a malicious application to the user.

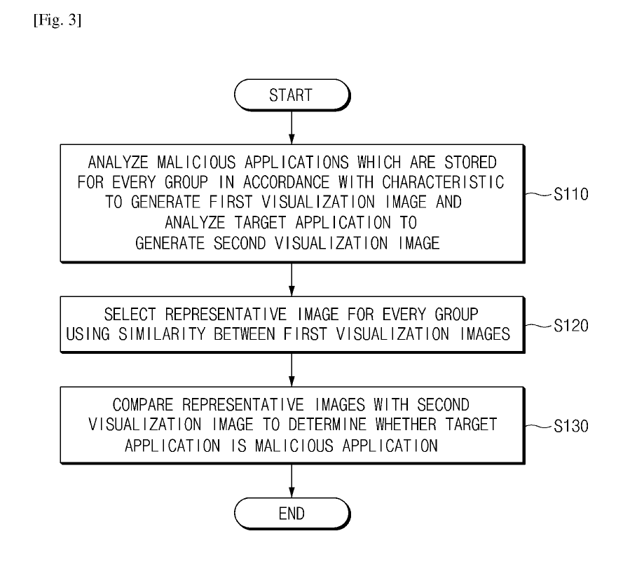

FIG. 3 is a flow chart illustrating a malicious application detecting method based on a visualization similarity according to an exemplary embodiment of the present invention.

Referring to FIG. 3, a malicious application detecting method based on a visualization similarity according to an exemplary embodiment of the present invention may include a step S110 of analyzing malicious applications which are stored for every group in accordance with characteristics to generate a first visualization image and analyzing a target application to generate a second visualization image, a step S120 of selecting a representative image for every group using a similarity of the first visualization images, and a step S130 of comparing the representative images with the second visualization image to determine whether the target application is a malicious application.

Hereinafter, steps S110 to S130 will be described in detail with reference to FIG. 1. Description with reference to FIG. 1 will not be repeated in order to avoid unnecessary redundancy.

In step S110, the image generating unit 130 analyzes the malicious applications which are stored for every group in the first storing unit 110 to generate first visualization images and analyzes the target application which is stored in the second storing unit 120 to generate a second visualization image.

In step S110, the image generating unit 130 decompresses a package file of the malicious applications which are stored in the first storing unit 110 to extract at least one of an execution file (for example, classes.dex), a resource access right file (androidmanifest.xml), and a metadata file. The image generating unit 130 may decompile the execution file (classes.dex) to extract a source code. The image generating unit 130 may generate a function list related with a malicious behavior or a character string list related with the malicious behavior based on the source code. Further, the image generating unit 130 analyzes the resource access permission file to generate an access permission list.

The image generating unit 130 decompresses a package file of the target application which is stored in the second storing unit 120 to extract at least one of an execution file (for example, classes.dex), a resource access permission file (androidmanifest.xml), and a metadata file. The image generating unit 130 may decompile the execution file (classes.dex) to extract a source code. The image generating unit 130 may generate a malicious behavior suspicious function list or a malicious behavior suspicious character string list based on the source code.

In step S120, the representative image selecting unit 140 may select representative images for every group using similarity of the first visualization images.

In step S130, the determining unit 150 compares representative images with the second visualization image to determine whether the target application is a malicious application.

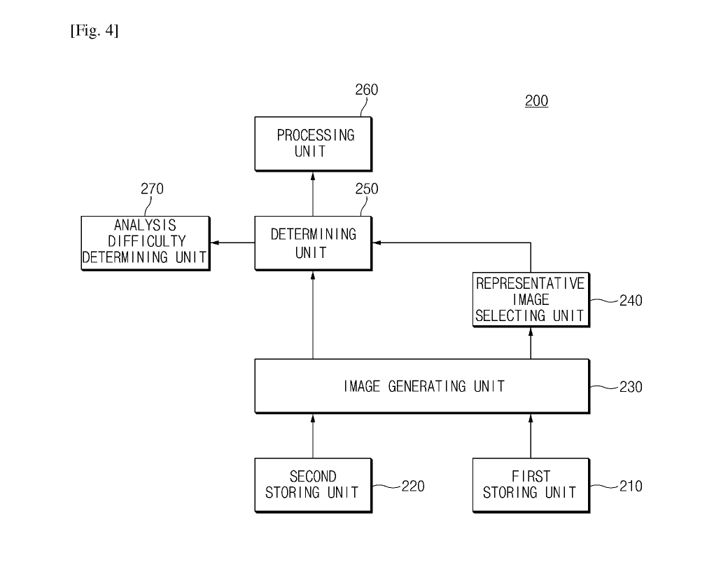

FIG. 4 is a block diagram illustrating a malicious application detecting apparatus based on a visualization similarity according to another exemplary embodiment of the present invention.

Referring to FIG. 4, a malicious application detecting apparatus 200 based on a visualization similarity according to another exemplary embodiment of the present invention 200 may include a first storing unit 210, a second storing unit 220, an image generating unit 230, a representative image selecting unit 240, a determining unit 250, a processing unit 260, and an analysis difficulty determining unit 270.

That is, as compared with the malicious application detecting apparatus 100 based on a visualization similarity illustrated in FIG. 1, the malicious application detecting apparatus 100 based on a visualization similarity illustrated in FIG. 4 may further include the processing unit 260 and the analysis difficulty determining unit 270.

Therefore, hereinafter, the processing unit 260 and the analysis difficulty determining unit 270 will be mainly described and it is understood that the first storing unit 210, the second storing unit 220, the image generating unit 230, the representative image selecting unit 240, and the determining unit 250 may have the same functions as the first storing unit 110, the second storing unit 120, the image generating unit 130, the representative image selecting unit 140, and the determining unit 150, respectively.

When it is determined that the target application is a malicious application, the processing unit 260 may classify the target application to a corresponding group and store the target application in the first storing unit 110. Therefore, information on the malicious application which is stored in the first storing unit 110 may be continuously updated.

When it is determined that the target application is a malicious application, the analysis difficulty determining unit 270 may determine analysis difficulty of the target application. The analysis difficulty determining unit 270 may determine the analysis difficulty based on at least one of a similarity comparing result of the representative images and the second visualization image, a similar degree of similar parts, the number of malicious applications of a group to which the target application is classified, a recent generation frequency of the malicious application of a group to which the target application is classified, and whether an obfuscation method is applied to the target application.

For example, the analysis difficulty determining unit 270 may determine that analysis difficulty for the target application is high as the similarity between the representative images and the second visualization image is lower, as the similar parts are increased, as the number of malicious applications of the group to which the target application is classified is smaller, and as the recent generation frequency of the malicious application of the group to which the target application is classified is lower. Further, when the obfuscation method is applied to the target application, the analysis difficulty determining unit 270 may determine that analysis difficulty for the target application is high. The analysis difficulty determining unit 270 may convert the analysis difficulty for the target application into a number (for example, N≧1, N is a natural number) and represent the analysis difficulty.

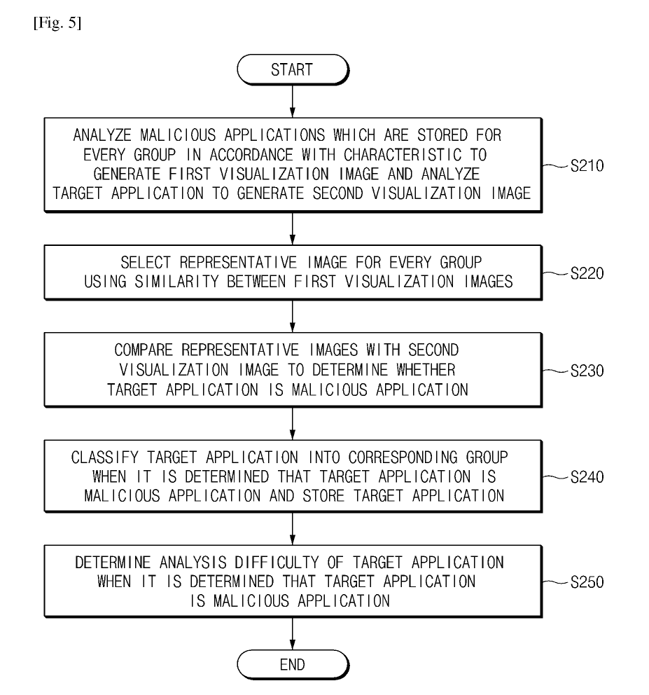

FIG. 5 is a flow chart illustrating a malicious application detecting method based on visualization similarity according to another exemplary embodiment of the present invention.

Referring to FIG. 5, a malicious application detecting method based on a visualization similarity according to another exemplary embodiment of the present invention may include a step S210 of analyzing malicious applications which are stored for every group in accordance with characteristics to generate a first visualization image and analyzing a target application to generate a second visualization image, a step S220 of selecting a representative image for every group using a similarity of the first visualization images, a step S230 of comparing the representative images with the second visualization image to determine whether the target application is a malicious application, a step S240 of classifying the target application into a corresponding group and storing the target application when it is determined that the target application is a malicious application, and a step S250 of determining analysis difficulty of the target application when it is determined that the target application is a malicious application. That is, as compared with the malicious application detecting method based on a visualization similarity illustrated in FIG. 3, the malicious application detecting method based on a visualization similarity according to the exemplary embodiment of the present invention may further include steps S240 and S250.

Hereinafter, steps S240 and S250 will be mainly described and it is understood that steps S210 to S230 are same as steps S110 to S130.

In step S240, when it is determined that the target application is a malicious application, the processing unit 260 may classify the target application to a corresponding group and store the target application in the first storing unit 110.

In step S250, when it is determined that the target application is a malicious application, the analysis difficulty determining unit 270 may determine analysis difficulty of the target application. The analysis difficulty determining unit 270 may determine the analysis difficulty based on at least one of a similarity comparing result of the representative images and the second visualization image, a similar degree of similar parts, the number of malicious applications of a group to which the target application is classified, a recent generation frequency of the malicious application of a group to which the target application is classified, and whether an obfuscation method is applied to the target application. The analysis difficulty determining unit 270 may convert the analysis difficulty for the target application into a number (for example, N≧1, N is a natural number) and represent the analysis difficulty.

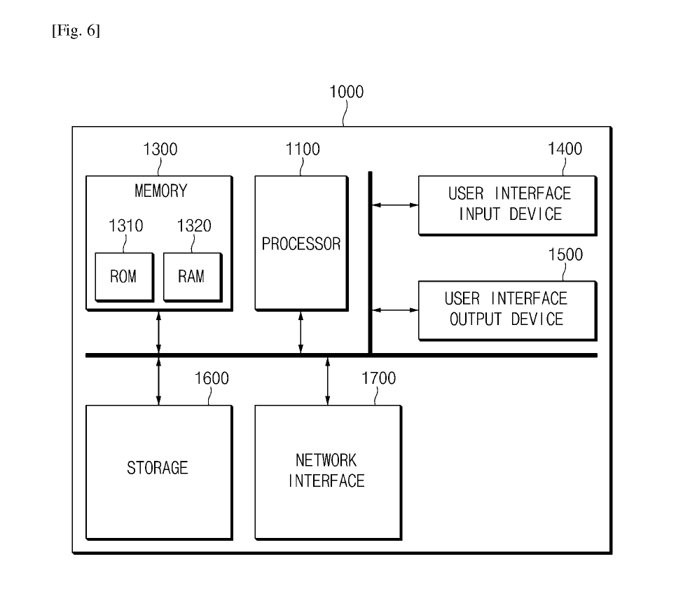

FIG. 6 is a block diagram illustrating a computing system which executes a malicious application detecting method based on visualization similarity according to an exemplary embodiment of the present invention.

Referring to FIG. 6, a computing system 1000 may include at least one processor 1100, a memory 1300, a user interface input device 1400, a user interface output device 1500, a storage 1600, and a network interface 1700 which are connected to each other through a bus 1200.

The processor 1100 may be a semiconductor device which may perform processings on commands which are stored in a central processing unit (CPU), or the memory 1300 and/or the storage 1600. The memory 1300 and the storage 1600 may include various types of volatile or non-volatile storage media. For example, the memory 1300 may include a read only memory (ROM) and a random access memory (RAM).

The method or a step of algorithm which has described regarding the exemplary embodiments disclosed in the specification may be directly implemented by a hardware or software module which is executed by a processor 1100 or a combination thereof. The software module may be stayed in a storage medium (that is, the memory 1300 and/or the storage 1600) such as a RAM, a flash memory, a ROM, an EPROM, an EEPROM, a register, a hard disk, a detachable disk, or a CD-ROM. An exemplary storage medium is coupled to the processor 1100 and the processor 1100 may read information from the storage medium and write information in the storage medium. As another method, the storage medium may be integrated with the processor 1100. The processor and the storage medium may be stayed in an application specific integrated circuit (ASIC). The ASIC may be stayed in a user terminal. As another method, the processor and the storage medium may be stayed in a user terminal as individual components.

It will be appreciated that various exemplary embodiments of the present disclosure have been described herein for purposes of illustration, and that various modifications and changes may be made by those skilled in the art without departing from the scope and spirit of the present invention.

Accordingly, the exemplary embodiments disclosed herein are not intended to limit but describe the technical spirit of the present invention and the scope of the technical spirit of the present invention is not restricted by the exemplary embodiments. The protection scope of the present invention should be interpreted based on the following appended claims and it should be appreciated that all technical spirits included within a range equivalent thereto are included in the protection scope of the present invention.

What is claimed is:

1. A malicious application detecting apparatus based on a visualization similarity, comprising:
a first storing unit which classifies malicious applications for every group in accordance with characteristics and stores the malicious applications;
a second storing unit which stores a target application;
an image generating unit which analyzes the malicious applications to generate first visualization images and analyzes the target application to generate a second visualization image;
a representative image selecting unit which selects representative images for every group using a similarity of the first visualization images; and
a determining unit which compares the representative images with the second visualization image to determine whether the target application is a malicious application.

2. The apparatus of claim 1, further comprising:
a processing unit which when it is determined that the target application is a malicious application, classifies the target application into a corresponding group to store the target application in the first storing unit.

3. The apparatus of claim 1, wherein the image generating unit decompresses a package file of the malicious applications to extract at least one of an execution file, a resource access permission file, and a metadata file.

4. The apparatus of claim 3, wherein the image generating unit decompiles the execution file to extract a source code and generates the first visualization images based on the source code.

5. The apparatus of claim 4, wherein the image generating unit generates a function list related with a malicious behavior or a character string list related with a malicious behavior based on the source code.

6. The apparatus of claim 1, wherein the image generating unit decompresses a package file of the target applications to extract at least one of an execution file, a resource access permission file, and a metadata file.

7. The apparatus of claim 6, wherein the image generating unit decompiles the execution file to extract a source code and generates the second visualization image based on the source code.

8. The apparatus of claim 7, wherein the image generating unit generates a malicious behavior suspicious function list or a malicious behavior suspicious character string list based on the source code.

9. The apparatus of claim 1, further comprising:
an analysis difficulty determining unit which, when it is determined that the target application is a malicious application, determines analysis difficulty of the target application.

10. The apparatus of claim 9, wherein the analysis difficulty determining unit determines analysis difficulty of the target application based on a similarity between the second visualization image and a representative image for every group, the number of malicious applications for every group, and a frequency of generation of a malicious application for every group.

11. A malicious application detecting method based on a visualization similarity, comprising:
analyzing malicious applications stored for every group in accordance with characteristics to generate first visualization images and analyzing a target application to generate a second visualization image;
selecting representative images for every group using a similarity of the first visualization images; and
comparing the representative images with the second visualization image to determine whether the target application is a malicious application.

12. The method of claim 11, wherein in the analyzing of malicious applications stored for every group in accordance with characteristics to generate first visualization images and the analyzing of a target application to generate a second visualization image; and a package file of the malicious applications is decompressed to extract at least one of an execution file, a resource access permission file, and a metadata file.

13. The method of claim 12, wherein in the analyzing of malicious applications stored for every group in accordance with characteristics to generate first visualization images and the analyzing of a target application to generate a second visualization image; and the execution file is decompiled to extract a source code and generate the first visualization images based on the source code.

14. The method of claim 13, wherein in the analyzing of malicious applications stored for every group in accordance with characteristics to generate first visualization images and the analyzing of a target application to generate a second visualization image and a function list related with a malicious behavior or a character string list related with a malicious behavior is generated based on the source code.

15. The method of claim 13, wherein in the analyzing of malicious applications stored for every group in accordance with characteristics to generate first visualization images and the analyzing of a target application to generate a second visualization image and the resource access permission file is analyzed to generate an access permission list.

16. The method of claim 11, wherein in the analyzing of malicious applications stored for every group in accordance with characteristics to generate first visualization images and the analyzing of a target application to generate a second visualization image and a package file of the target applications is decompressed to extract at least one of an execution file, a resource access permission file, and a metadata file.

17. The method of claim 16, wherein in the analyzing of malicious applications stored for every group in accordance with characteristics to generate first visualization images and the analyzing of a target application to generate a second visualization image and the execution file is decompiled to extract a source code and generate the second visualization image based on the source code.

18. The method of claim 17, wherein in the analyzing of malicious applications stored for every group in accordance with characteristics to generate first visualization images and the analyzing of a target application to generate a second visualization image and a malicious behavior suspicious function list or a malicious behavior suspicious character string list is generated based on the source code.

19. The method of claim 11, further comprising:
classifying the target application into a corresponding group to store the target application when it is determined that the target application is a malicious application; and
determining analysis difficulty of the target application when it is determined that the target application is a malicious application.

20. The method of claim 19, wherein in the determining of analysis difficulty of the target application when it is determined that the target application is a malicious application and analysis difficulty of the target application is determined based on at least one of a similarity between the second visualization image of the target application and a representative image for every group, the number of malicious applications for every group, and a frequency of generation of a malicious application for every group.
